(19) United States
(12) Patent Application Publication
(10) Pub. No.: US 2022/0154789 A1
(43) Pub. Date: May 19, 2022

(54) DUST SHIELD FOR HEAVY-DUTY VEHICLE BRAKE SYSTEMS

(71) Applicant: Hendrickson USA, L.L.C., Schaumburg, IL (US)

(72) Inventor: Matthew P. Karich, Fairlawn, OH (US)

(21) Appl. No.: 17/501,027

(22) Filed: Oct. 14, 2021

Related U.S. Application Data
(60) Provisional application No. 63/113,370, filed on Nov. 13, 2020.

(51) Int. Cl. F16D 65/00; F16D 55/22

(52) U.S. Cl. CPC F16D 65/0081; F16D 2055/0037; F16D 65/0006; F16D 55/22

(57) ABSTRACT

A dust shield for a disc brake assembly of a heavy-duty vehicle, the dust shield comprising a central portion and a substantially flat portion. The flat portion is integrally formed with and extends radially outward from the central portion. The central portion extends axially inboard of and forms a flange axially-offset from and parallel to the flat portion to act as a stiffening rib to increase the natural frequency of the dust shield.

### CROSS-REFERENCE TO RELATED APPLICATION

This application claims the benefit of U.S. Provisional Patent Application No. 63/113,370, filed Nov. 13, 2020.

### BACKGROUND OF THE INVENTION

### Field of the Invention

The invention relates to the art of brake systems for heavy-duty vehicles. In particular, the invention relates to heavy-duty vehicle brake systems utilizing disc brake rotors. More particularly, the invention is directed to a dust shield for disc brake rotors that includes a deep-drawn central section that increases stiffness, altering the natural frequency of the dust shield, thereby reducing or eliminating vibration and/or deflection of and potential damage to the dust shield as well as reducing or eliminating potential separation of the dust shield from the torque plate.

### Background Art

The use of brake systems on heavy-duty vehicles is well known. For the purposes of clarity and convenience, reference is made to a heavy-duty vehicle with the understanding that such reference includes trucks, tractor-trailers or semi-trailers, trailers, and the like. Common types of brake systems for heavy-duty vehicles typically include disc brake systems and drum brake systems.

Disc brake systems are generally incorporated into an axle/suspension system of the heavy-duty vehicle. More specifically, disc brake systems typically include a plurality of disc brake assemblies, each operatively mounted on or adjacent a respective wheel end assembly of the heavy-duty vehicle. Each wheel end assembly, in turn, is rotatably mounted on an axle of the heavy-duty vehicle, as is known. A pair of suspension assemblies connects the axle to members of a frame or subframe of the heavy-duty vehicle, forming the axle/suspension system. For those heavy-duty vehicles that support a subframe, the subframe can be non-movable or movable, the latter being commonly referred to as a slider box, slider subframe, slider undercarriage, secondary slider frame, or bogey.

Each disc brake assembly typically includes a torque plate, a carrier, a caliper, and a rotor. The torque plate is mounted to the axle inboardly of the wheel end assembly. The carrier is attached to the torque plate by mechanical fasteners and supports the caliper, as is known. The caliper is formed with a bore for receiving an actuator and a piston or multiple pistons. The actuator typically has an air chamber, or brake chamber, that is in fluid communication with a compressed air source and activates movement of the piston. The caliper also includes a pad seat that is disposed outboardly of and opposite the piston. The caliper typically holds a pair of opposing brake pads having friction material mounted to a backing plate. More specifically, each one of the brake pads is seated in the carrier such that one of the brake pads is adjacent the piston and the other brake pad is adjacent the outboard pad seat. The brake pads are seated such that the friction material of each brake pad is in opposition.

The rotor of each disc brake assembly is mounted to the respective wheel end assembly for rotation. The rotor includes a disc portion that extends radially outward from the wheel end assembly and is disposed between the opposing brake pads to allow the friction material of each pad to face and engage a respective surface of the disc portion.

During operation of the heavy-duty vehicle, when the vehicle brake system is engaged, compressed air flows to the brake chamber, causing movement of the piston and the outboard pad seat, forcing the brake pads toward one another. The friction material of the brake pads contacts the disc portion of the rotor, thereby slowing and/or stopping the heavy-duty vehicle.

However, certain road conditions may have undesirable effects on the rotor. In particular, when the heavy-duty vehicle travels over roads, moisture, chemicals, and/or debris on the road surface may be directed upward and contact or accumulate on certain components of the disc brake assembly, including the rotor. The accumulation of moisture, chemicals, and/or debris may create a scouring effect, potentially rendering the rotor more susceptible to corrosion. More particularly, the inboard surface of the rotor is particularly exposed to moisture, chemicals, and/or debris such that the inboard surface is more susceptible to corrosion. Corrosion of the inboard surface of the rotor may potentially cause the corresponding brake pad to wear prematurely due to contact with the corroded surface. As a result, the performance and service life of the rotor as well as the brake pads may be reduced.

In order to reduce the amount of moisture, chemicals, and/or debris that contact the inboard surface of the rotor, prior art rotor or dust shields have been employed. Prior art dust shields are typically statically-mounted structures rigidly attached to the axle or the torque plate inboardly of the rotor that attempt to prevent moisture, chemicals, and/or debris from directly contacting the inboard surface of the rotor. More specifically, prior art dust shields typically include a simple sheet or wall attached to the outboard surface of the torque plate at a location that is axially-spaced about an inch or more from the inboard surface of the rotor. Alternatively, the wall may be clamped or rigidly attached to the axle adjacent the outboard surface of the torque plate.

The wall of prior art dust shields extends radially outward from the outer surface of the axle and slightly past the outer periphery, or edge, of the rotor. In some prior art dust shields, the wall may include an axially-outboard extending portion, or lip, that extends over a portion of the outer periphery of the rotor. The wall of prior art dust shields may also be formed with a plurality of spaced-apart features, including vent louvres and/or indentations, intended to allow moisture, chemicals, and/or debris to escape or be ejected from in-between the inboard surface of the rotor and the wall.

Prior art dust shields, while performing adequately, have certain disadvantages, drawbacks, and limitations. For example, during operation, movement of the axle/suspension system and vibration of the heavy-duty vehicle may potentially exacerbate the natural frequency of the prior art dust shield at or below 85 Hz, increasing modal vibration of the dust shield. Increased vibration of the prior art dust shield may potentially cause rapid deflection of the dust shield. Over a period of time, deflection of the prior art dust shield may potentially cause increased stress and fatigue of the dust shield, especially at and around the fasteners attaching the dust shield to the torque plate. This increased stress and fatigue may potentially cause damage to or separation of the prior art dust shield from the torque plate, exposing the inboard surface of the rotor to moisture, chemicals, and/or debris, thereby reducing the performance and service life of the rotor and/or brake pad.

Thus, there is a need for a dust shield for heavy-duty vehicle brake systems that has increased stiffness and durability and a relatively higher natural frequency in order to reduce the amount of deflection the dust shield experiences during operation, reducing potential damage to and/or separation of the dust shield from the torque plate, thereby maintaining protection of the inboard surface of the rotor from moisture, chemicals, and/or debris.

### SUMMARY OF THE INVENTION

Objectives of the present invention include providing a dust shield having increased stiffness and durability.

A further objective of the present invention is to provide a dust shield having a relatively higher natural frequency to reduce deflection.

These objectives and advantages are obtained by the dust shield for a disc brake assembly of a heavy-duty vehicle of the present invention, the dust shield comprising a central portion and a substantially flat portion. The flat portion is integrally formed with and extends radially outward from the central portion. The central portion extends axially inboard of and forms a flange axially-offset from and parallel to the flat portion to act as a stiffening rib to increase the natural frequency of the dust shield.

### BRIEF DESCRIPTION OF THE SEVERAL VIEWS OF THE DRAWINGS

The preferred embodiment of the present invention, illustrative of the best mode in which applicants have contemplated applying the principles, is set forth in the following description, shown in the drawings, and particularly and distinctly pointed out and set forth in the appended claims.

FIG. 1 is a fragmentary perspective view, looking in an outboard direction, of an axle/suspension system with a prior art dust shield incorporated into a brake assembly;

FIG. 2 is a fragmentary elevational view, partially in section, of the wheel end assembly and a portion of the brake assembly shown in FIG. 1, with the prior art dust shield removed;

FIG. 3 is an elevational view, looking in an outboard direction, with hidden portions represented by dashed lines, of the prior art dust shield shown in FIG. 1;

FIG. 4 is a perspective view, looking in an outboard direction, of an exemplary embodiment dust shield, according to the present invention, showing the dust shield mounted to a radially mounting torque plate;

FIG. 5 is a perspective view, looking in an inboard direction, of the exemplary embodiment dust shield shown in FIG. 4, showing the dust shield mounted to a radially mounting torque plate; and

FIG. 6 is a perspective view, with portions broken away, of the exemplary embodiment dust shield shown in FIGS. 4-5.

Similar characters refer to similar parts throughout.

### DESCRIPTION OF THE PREFERRED EMBODIMENT

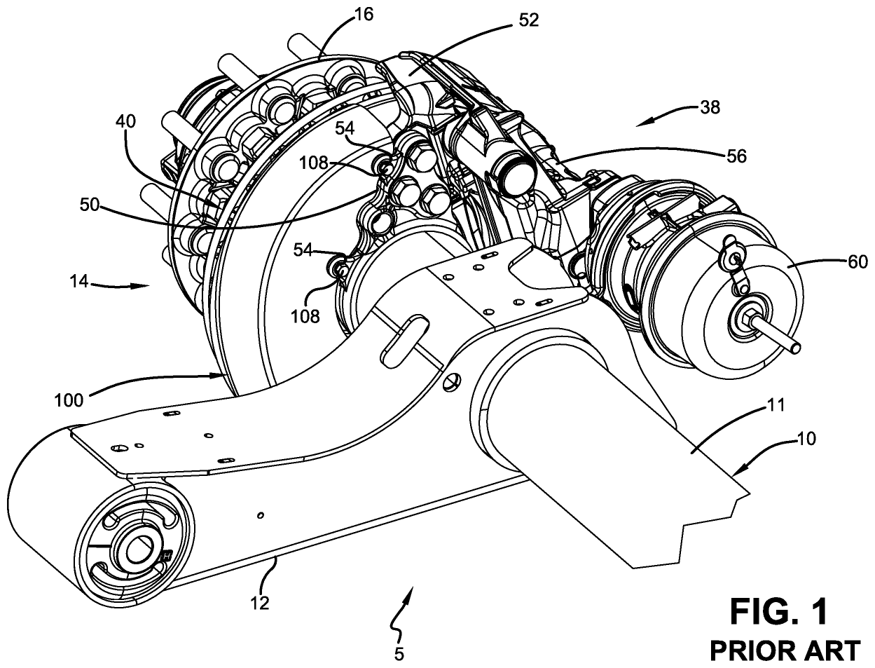

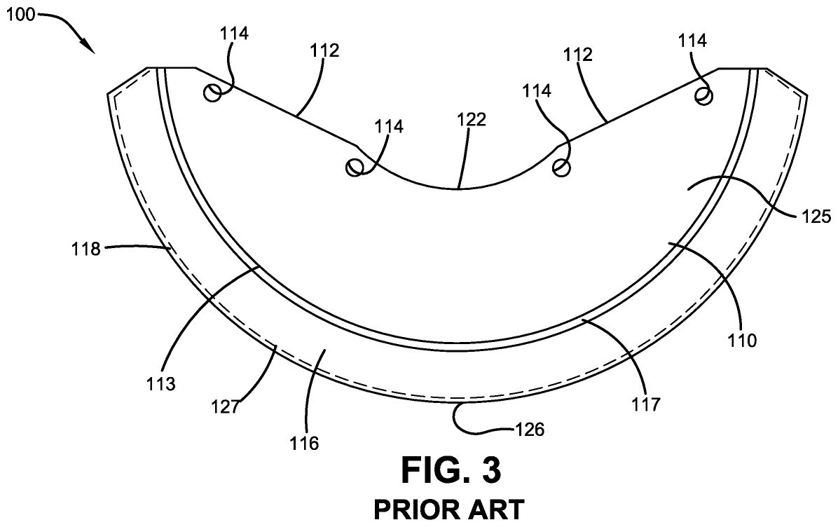

In order to better understand the environment in which the dust shield of the present invention is utilized, a prior art dust shield 100 (FIGS. 1 and 3) is shown attached to an axially mounting torque plate 50 incorporated into a disc brake assembly 38 (partially shown) mounted on an axle/suspension system 5 (partially shown). As is understood in the art, axially mounting torque plates, such as torque plate 50, uses axially-oriented fasteners to mount carriers and/or calipers.

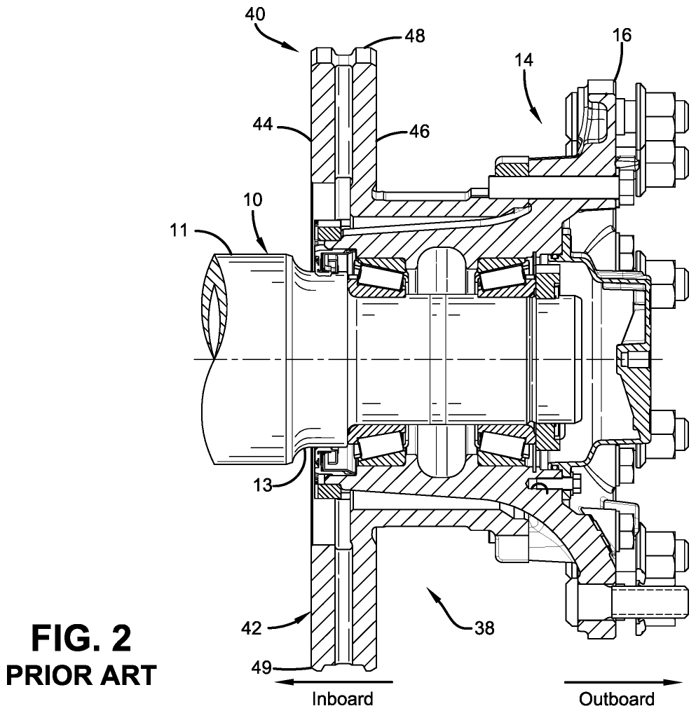

Axle/suspension system 5 includes an axle 10 and a pair of beams 12 (only one shown). Axle 10 includes a central tube 11 and a pair of axle spindles 13 (FIG. 2) (only one shown) fixedly attached to opposite ends of the central tube by any suitable means, such as welds. Each one of the pair of beams 12 is spaced apart along and rigidly attached to central tube 11 by any suitable method, such as welding.

Each brake assembly 38 includes torque plate 50, a carrier 52, a caliper 56, and a rotor 40. Torque plate 50 is rigidly attached, such as by welding, to central tube 11. Carrier 52 is mechanically fastened to torque plate 50 and supports caliper 56, as is known. Caliper 56 is formed with a bore (not shown) for receiving one or more pistons (not shown). Caliper 56 includes a brake air chamber or actuator 60 in fluid communication with a compressed air source (not shown) for activating movement of the piston. Caliper 56 also includes an outboard pad seat (not shown) that is disposed opposite the piston, as is known. A pair of brake pads (not shown) having friction material mounted on a backing plate are seated in carrier 52 on respective opposing sides of rotor 40, such that one of the brake pads is adjacent the piston of caliper 56 and the other brake pad is adjacent the outboard pad seat.

Rotor 40 is removably attached to a wheel hub 16 of a wheel end assembly 14, as is known. Wheel end assembly 14, in turn, is rotatably mounted on spindle 13. Rotor 40 includes a radially-extending disc portion 42 (FIG. 2) having an inboard surface 44, an outboard surface 46, and an outer edge or periphery 48. Disc portion 42 is disposed between the opposing brake pads such that the inboard and outboard surfaces 44, 46, respectively are each located adjacent the friction material of respective brake pads, as is known.

During operation of the heavy-duty vehicle, when brake assembly 38 is engaged, compressed air flows to actuator 60, activating movement of the piston, which, in turn, causes movement of caliper 56 and the outboard pad seat. As a result, the friction material of the brake pads is forced against the respective inboard and outboard surfaces 44, 46 of disc portion 42, slowing or stopping the heavy-duty vehicle. However, during operation, inboard surface 44 of disc portion 42 is particularly exposed to moisture, chemicals, and/or debris such that the inboard surface is potentially susceptible to corrosion. Corrosion of inboard surface 44 may potentially cause premature wear of the respective brake pad, reducing the performance and service life of rotor 40 and at least the inboard brake pad.

Prior art dust shield 100 is employed to reduce the amount of moisture, chemicals, and/or debris that contact and/or accumulate on inboard surface 44 of disc portion 42 of rotor 40. Prior art dust shield 100 generally includes a substantially semi-circular or crescent-shaped flat wall 110 (FIG. 3) extending radially-outward from and perpendicular to axle 10. Flat wall 110 includes an inboard surface 125, an outboard surface 126, and a radially outer edge or periphery 113. Inboard and outboard surfaces 125, 126, respectively, may be smooth or may be formed with axially-protruding surface features, such as vent louvers (not shown) and/or indentations (not shown). Flat wall 110 also includes a concave central axle feature 122. Axle feature 122 is formed with a shape that allows prior art dust shield 100 to tightly conform to the contour of the portion of torque plate 50 disposed about axle 10. Flat wall 110 is formed with a plurality of openings 114 having a spaced-apart arrangement proximate to a pair of lateral edges or peripheries 112. Openings 114 correspond to and align with features, such as projections or openings 54 (FIG. 1), formed in torque plate 50, allowing prior art dust shield 100 to be mounted to the torque plate. More specifically, respective fasteners 108 are disposed through aligned openings 114, 54 to removably secure dust shield 100 to torque plate 50.

Prior art dust shield 100 may also include a sidewall 116 integrally formed with and extending radially outwardly from flat wall 110. More specifically, flat wall 110 may be formed with a bend 117 that provides a transition between the flat wall and sidewall 116. Sidewall 116 extends radially outwardly and axially outboardly from bend 117 past outer periphery 48 of disc portion 42 of rotor 40, protecting inboard surface 44 of the disc portion. Sidewall 116 may also include an integrally-formed lip 118. More specifically, sidewall 116 may be formed with a bend 127 that provides a transition from the sidewall to lip 118. Lip 118 may extend radially outwardly and/or axially outboardly from the outer edge of sidewall 116.

However, during operation of the heavy-duty vehicle, movement of the axle/suspension system and vibration of the heavy-duty vehicle may potentially exacerbate the natural frequency of prior art dust shield 100 at or below 85 Hz, increasing vibration of the dust shield. Increased vibration of prior art dust shield 100 may potentially cause rapid deflection that, over a period of time, may potentially result in damage to or detachment of the dust shield from torque plate 50. More specifically, increased vibration of prior art dust shield 100 may potentially cause cracking of the dust shield adjacent to openings 114 and fasteners 108. As a result, prior art dust shield 100 may potentially not provide protection of inboard surface 44 of disc portion 42 of rotor 40 from contact with and/or accumulation of moisture, chemicals, and/or debris, thereby reducing performance and service life of the rotor and/or brake pads.

Thus, there is a need for a dust shield for heavy-duty vehicles that has relatively greater stiffness and durability and reduced amount of deflection during operation, reducing potential damage to and detachment of the dust shield from the torque plate, thereby maintaining protection of the rotor from moisture, chemicals, and/or debris.

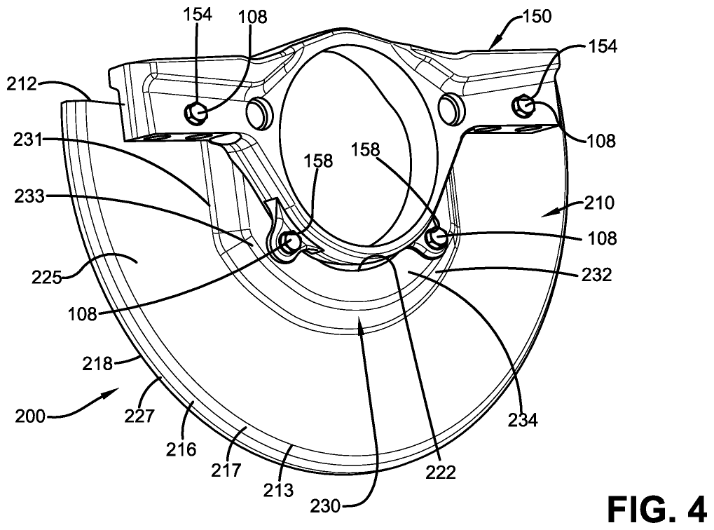

An exemplary embodiment dust shield 200 (FIGS. 4-6) for heavy-duty vehicles, according to the present invention, is removably attached to a radially mounting torque plate 150. As is understood in the art, radially mounting torque plates, such as torque plate 150, use radially oriented fasteners to mount carriers and or calipers. It is understood that dust shield 200 may be mounted to any other suitable torque plate, including axially mounting torque plate 50, described above, and incorporated into any suitable brake assembly, such as brake assembly 38, described above.

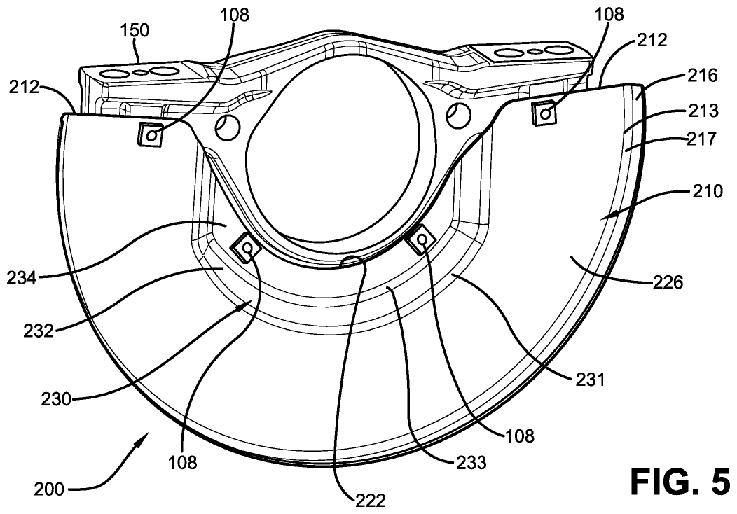

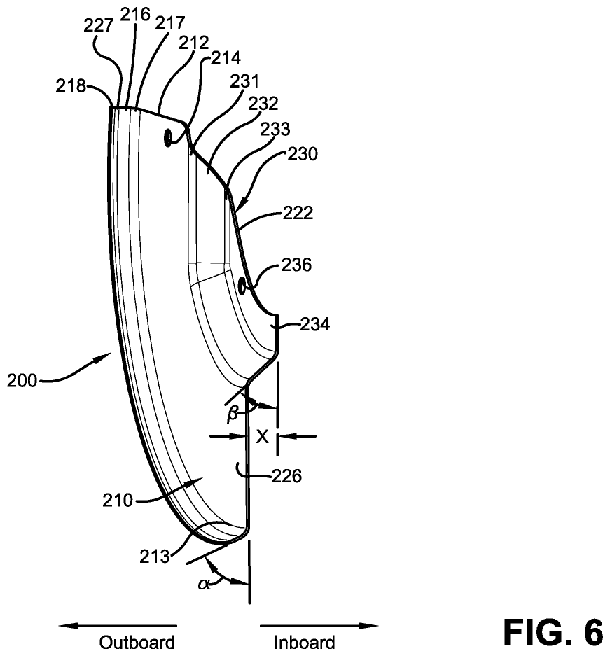

Dust shield 200 is formed from any suitable material, such as steel, using any suitable process and includes a planar or substantially flat portion 210 that is substantially semi-circular or semi-annular. It is also contemplated that dust shield 200 may have any other suitable shape, including a crescent shape or the like. Flat portion 210 is arranged perpendicularly to axle 10 and includes an inboard surface 225, an outboard surface 226 (FIGS. 5-6), a pair of lateral edges or peripheries 212, and a radially outer periphery 213. Inboard and outboard surfaces 225, 226, respectively, are generally smooth. It is also contemplated that inboard and outboard surfaces 225, 226, respectively, may be formed with any suitable axially-protruding surface features, such as vent louvers and/or indentations while still maintaining the substantially flat or planar characteristics of flat portion 210. Flat portion 210 also includes a pair of openings 214 (FIG. 6) (only one shown). Each of openings 214 are formed through flat portion 210 adjacent respective lateral peripheries 212 and correspond to and align with respective openings 154 formed through torque plate 150, allowing dust shield 200 to be mounted to the torque plate. More specifically, respective fasteners 108 are disposed through aligned openings 214, 154 to secure dust shield 200 to torque plate 150.

Dust shield 200 may also include a sidewall 216 integrally-formed with and extending radially outwardly from flat portion 210. More specifically, flat portion 210 may be formed with a bend 217 that provides a transition between the flat portion and sidewall 216. Sidewall 216 extends radially outwardly from bend 217 past outer periphery 48 (FIG. 2) of disc portion 42 of rotor 40 to protect inboard surface 44 of the rotor. Sidewall 216 also extends axially outboardly such that the sidewall forms an angle α (FIG. 6) relative to flat portion 210. Angle α may vary, corresponding to the size of rotor 40. As a result, angle α may be in the range of from about 45 degrees to about 75 degrees, more preferably from about 60 degrees to about 70 degrees. Angle a of sidewall 216 enables dust shield 200 to be disposed in optimal proximity to an inboard corner 49 (FIG. 2) of outer periphery 48 of disc portion 42. In particular, sidewall 216 is sufficiently close to inboard corner 49 to prevent moisture, chemicals, and/or debris from contacting inboard surface 44 of disc portion 42, while being sufficiently distanced to allow the egress of moisture, chemicals, and/or debris from between the inboard surface and dust shield 200. More particularly, sidewall 216 is spaced a distance of from about 0.375 inches to about 0.5 inches from inboard corner 49.

Sidewall 216 may also be formed with an integral lip 218. More specifically, sidewall 216 may be formed with a bend 227 that provides a transition from the sidewall to lip 218. Lip 218 may extend radially outwardly and/or axially outboardly from an outer edge of sidewall 216. Preferably, lip 218 extends axially outboardly perpendicular to flat portion 210 and rotor 40 for a distance of about 0.125 inches.

In accordance with an important aspect of the present invention, dust shield 200 also includes a central portion 230. In particular, central portion 230 may be axially concave or inboardly recessed from flat portion 110. More particularly, central portion 230 includes an oblique section 232 and a flange 234. Oblique section 232 may be integrally formed with and extend generally axially-inboard from a bend 231 of flat portion 210. Bend 231 provides a smooth transition between flat portion 210 and oblique section 232. Oblique section 232 extends an axial distance X (FIG. 6) inboard of flat portion 210. Distance X may vary depending on the type of torque plate or other components or aspects of brake assembly 38 into which dust shield 200 is incorporated. Distance X may be in the range from about 0.25 inches to about 1.1 inches, more preferably from about 0.35 inches to about 0.85 inches. Oblique section 232 also extends radially-inward such that the oblique section extends from flat portion 210 at an angle β. It is contemplated that angle β may vary along distance X such that the oblique section may be curved. More specifically, angle β may be in the range of from about 35 degrees to about 75 degrees, more preferably from about 45 degrees to about 55 degrees.

Flange 234 of central portion 230 extends radially inward from oblique section 232 parallel to flat portion 210 and perpendicular to axle 10. More specifically, flange 234 extends from a bend 233 of oblique section 232. Bend 233 provides a smooth transition between oblique section 232 and flange 234. Flange 234 is formed with a radially-concave central edge or periphery 222 that enables dust shield 200 to tightly conform to the contour of the portion of torque plate 150 disposed about axle 10, minimizing space between the dust shield, the torque plate, and the axle, thereby protecting inboard surface 44 of disc portion 42 of rotor 40 from moisture, chemicals, and/or debris. Flange 234 may also be formed with one or more openings 236 (FIG. 6) (only one shown). Preferably, flange 234 may be formed with a pair of openings 236 in circumferentially-spaced arrangement proximate to central periphery 222. More specifically, openings 236 align with corresponding features, such as openings 158 formed through torque plate 150. Aligned openings 236, 158 receive respective fasteners 108 to enable dust shield 100 to be secured to the outboard surface of torque plate 150 in close proximity to the inboard surface of disc portion 42 of rotor 40.

In accordance with an important aspect of the present invention, central portion 230 of dust shield 200 provides the dust shield with increased stiffness. In particular, central portion 230 of dust shield 100 is integrally formed from flat portion 210 using any suitable method, but preferably using deep drawing. Deep drawing central portion 230 from flat portion 210 allows the central portion to act in the manner of a stiffening rib. As a result, central portion 230 increases the natural frequency of and/or redirects vibrations through dust shield 200 caused by movement of axle/suspension system 5 and vibration of the heavy-duty vehicle during operation. More specifically, central portion 230 increases the natural frequency of dust shield 200 above 85 Hz, reducing the amount of vibration and deflection the dust shield experiences during operation, increasing durability of the dust shield. In addition, central portion 230 redirects vibration relatively farther away from openings 214, 236 and fasteners 108 as compared to prior art dust shield 100, thereby reducing potential cracking and separation of dust shield 200 from torque plate 150. It is also contemplated that torque plate 150 may utilize additional components or features, such as standoffs or bosses, that complement the stiffening provided by central portion 230, further increasing the natural frequency above 85 Hz. It is also contemplated that dust shield 200 can be tuned for utilization with any other suitable torque plate. More specifically, distance X and angle β of oblique section 232 may be modified in accordance with the torque plate on which dust shield 200 is installed in order to increase the natural frequency of the dust shield and/or redirect vibration away from openings 214, 236 and fasteners 108. As a result, dust shield 200 experiences a reduced amount of vibration and/or deflection during operation because the natural frequencies are raised above the frequencies generated by axle/suspension system 5 and the heavy-duty vehicle during operation, especially proximate to openings 214, 236 and about fasteners 108. Thus, stress and fatigue on the dust shield is reduced or eliminated, preventing damage to and/or separation of the dust shield from torque plate 150 and preventing exposure of inboard surface 44 of rotor 40 to moisture, chemicals, and/or debris.

Thus, dust shield 200, according to the present invention, provides a deep drawn central portion 230 that increases the stiffness and durability of the dust shield, increasing the natural frequency of the dust shield above 85 Hz, thereby reducing or eliminating vibration and/or deflection of the dust shield during operation, which prevents damage to or separation of the dust shield from torque plate 150, increasing the service life and performance of rotor 40. In addition, dust shield 200 increases accessibility to fasteners mounting caliper 56 to certain torque plates, such as torque plate 150, by providing central portion 230 axially recessed from flat portion 210, thereby facilitating installation and removal of the dust shield.

It is contemplated that dust shield 200, according to the present invention, may include a protective or friction-reducing coating, such as an epoxy-based or acrylic-based electro-coating or e-coating, on at least outboard surface 226 of the dust shield to prevent the formation of corrosion cells without affecting the overall concept or operation of the invention. It is also contemplated that other suitable types of coatings, including those applied using dipping, spraying, particle deposition, or any other suitable techniques, may be employed with dust shield 200 in order to prevent accumulation of moisture, chemicals, and/or debris on inboard and/or outboard surfaces 225, 226, respectively, without affecting the overall concept or operation of the invention. It is yet further contemplated that dust shield 200 may be employed with other types of axles, wheel end assemblies, axle/suspension systems, brake systems and assemblies, and/or torque plates, including axial mounting torque plates, than those shown and described herein without affecting the overall concept or operation of the invention.

Accordingly, the dust shield of the present invention is simplified; provides an effective, safe, inexpensive, and efficient structure and method, which achieves all the enumerated objectives; provides for eliminating difficulties encountered with prior dust shields; and solves problems and obtains new results in the art.

In the foregoing description, certain terms have been used for brevity, clarity, and understanding; but no unnecessary limitations are to be implied therefrom beyond the requirements of the prior art because such terms are used for descriptive purposes and are intended to be broadly construed. Moreover, the description and illustration of the invention is by way of example, and the scope of the invention is not limited to the exact details shown or described. Potential modifications and alterations will occur to others upon a reading and understanding of this disclosure, and it is understood that the invention includes all such modifications, alterations, and equivalents thereof.

Having now described the features, discoveries, and principles of the invention; the manner in which the dust shield of the present invention is used and installed; the characteristics of the construction, arrangement, and method steps; and the advantageous, new and useful results obtained, the new and useful structures, devices, elements, arrangements, process, parts, and combinations are set forth in the appended claims.

What is claimed is:

1. A dust shield for a disc brake assembly of a heavy-duty vehicle, said dust shield comprising:
a central portion; and
a substantially flat portion integrally formed with and extending radially outward from said central portion, said central portion extending axially inboard of and forming a flange axially offset from and parallel to said flat portion;
wherein said central portion acts as a stiffening rib to increase the natural frequency of the dust shield.

2. The dust shield for a disc brake assembly of heavy-duty vehicles of claim 1, said flange being axially offset from said flat portion a distance in the range of from about 0.25 inches to about 1.1 inches.

3. The dust shield for a disc brake assembly of heavy-duty vehicles of claim 1, said flange being axially offset from said flat portion a distance in the range of from about 0.35 inches to about 0.85 inches.

4. The dust shield for a disc brake assembly of heavy-duty vehicles of claim 1, said central portion further comprising an oblique section, said oblique section extending axially inboardly and radially inwardly from said flat portion toward said flange.

5. The dust shield for a disc brake assembly of heavy-duty vehicles of claim 4, said oblique section extending from said flat portion at an angle in the range of from about 35 degrees to about 75 degrees.

6. The dust shield for a disc brake assembly of heavy-duty vehicles of claim 4, said oblique section extending from said flat portion at an angle in the range of from about 45 degrees to about 55 degrees.

7. The dust shield for a disc brake assembly of heavy-duty vehicles of claim 1, said central portion being formed by deep drawing.

8. The dust shield or a disc brake assembly of heavy-duty vehicles of claim 1, said flat portion further comprising a sidewall extending radially outward and axially outboard from the flat portion.

9. The dust shield or a disc brake assembly of heavy-duty vehicles of claim 8, said sidewall extending from said flat portion at an angle in the range of from about 45 degrees to about 75 degrees.

10. The dust shield or a disc brake assembly of heavy-duty vehicles of claim 8, said sidewall extending from said flat portion at an angle in the range of from about 50 degrees to about 70 degrees.
